(19) United States
(12) Patent Application Publication
(10) Pub. No.: US 2011/0063226 A1
(43) Pub. Date: Mar. 17, 2011

(54) T-board

(76) Inventor: Philip Brent Hover, Weston, CT (US)

(21) Appl. No.: 12/584,968

(22) Filed: Sep. 15, 2009

(51) Int. Cl. G06F 3/02

(52) U.S. Cl. 345/169

(57) ABSTRACT

The invention, named herein as the T-Board, relates to a keyboard (FIG. 1) to be used as a computer peripheral for data entry. The preferred embodiment comprises a keyboard having mounted thereon a number of keys, the keyboard (FIG. 1) being formed as a single unit small enough to be handheld or “pocket sized”. The exact size of the unit could vary in order to accommodate design variations. The device would enable a user to utilize the device in a manner similar to “texting” on a cell phone (or similar), but this device would interface with a standard personal computer, laptop computer, etc. via an integrated Universal Serial Bus port (e.g. USB/USB 2.0) (FIG. 2).

The use of this device would provide myriad benefits to the user in simplification of the “typing” or input process, reduction in the type of injuries commonly associated with common keyboards and numerous environmental benefits to the user, the work or study location, and the planetary environment as a whole.

### FIELD OF THE INVENTION

The following invention relates to computer keyboards, and more particularly, though not exclusively, to a handheld or “pocket-sized” computer keyboard.

### PRIOR ART

Known keyboard of the type used at a computer terminal for example, comprise a unitary board onto which a plurality of alpha numeric keys are attached. It is a disadvantage of such known keyboards that the same is not handheld. The smaller size allows for greater convenience in typing especially to those members of society who send “text messages” on cell phones, for example. It is common practice to utilize less than all of one's digits for that practice and, commonly, only thumbs are used. It is the size of this keyboard which permits the same to be handheld and utilized in the same manner as “texting” as it is commonly known.

It is also a disadvantage of such known keyboards that the wrists and/or arms and shoulders of the user must be contorted into a posture which is stressful to the user after prolonged use of the keyboard which could be eliminated through the utilization of this invention.

It is also a disadvantage of the common keyboard that the user's wrists suffer pronation and/or supination thereby causing injury to the user which could be eliminated through the utilization of this invention.

It is also a disadvantage of the common keyboard that the manufacture, distribution, storage, transport and distribution of the same utilizes too many raw materials, natural resources, space and overly burdens our environment which could be eliminated through the utilization of this invention.

### OBJECT OF THE INVENTION

It is the object of the present invention: (1) to facilitate data input to a computer (or similar) by those users who would prefer a handheld, computer keyboard; (2) to eliminate the above potential for injury to user; (3) to benefit the environment of the planet by using fewer resources in the manufacture, storage, distribution, transportation and disposition of the invention; (4) to conserve space during the storage and use of the invention; and (5) to decrease the weight of device when transported both during retail distribution and by the user.

### DISCLOSURE OF THE INVENTION

There is disclosed herein a computer keyboard having mounted thereon a plurality of keys. The keyboard unit itself is substantially smaller than the normal size keyboard typically found in office or study environments as computer peripherals.

The size of this unit would typically allow the same to be held between the two hands of the user who would grasp the unit at opposing ends and depress the keys normally (but not exclusively) with the user's thumbs rather than all fingers. The same is also intended to be small enough to be considered “pocket-sized”.

### ADVANTAGES OF THE INVENTION

1. Those users who commonly send text messages on cell phones would be able to interface with their computers in a similar fashion. Presently, those who send such text messages depress the keys in a manner different from the use of the common computer keyboard. The former typically utilizing thumbs; the latter commonly utilizing more (or all) fingers and/or thumbs. Thus, users would not have to learn how to type using two different methods.
2. This unit, being substantially smaller than the common keyboard, would use fewer natural resources in the production thereof thereby benefiting the environment.
3. This unit, being substantially smaller than the common keyboard, would take up less desk surface area thereby facilitating the utilization of space in the work or study environment.
4. This unit could diminish the occurrence of repetitive stress injuries which have been associated with the common keyboard including carpal tunnel syndrome.
5. This unit could diminish the discomfort to the user caused by pronation of the wrists and/or supination of the wrists.
6. This unit could diminish the postural problems experienced by users of standard or common keyboards.
7. This unit, being substantially smaller than the common keyboard, would generate less waste at the end of its useful life thereby benefiting the environment.
8. This unit, being substantially smaller than the common keyboard, would generate less packaging materials during its distribution and marketing thereby benefiting the environment.
9. This unit, being substantially lighter and smaller than the common keyboard, would facilitate portability in the event the user needed to relocate its work or study location.
10. This unit, being substantially lighter and smaller than the common keyboard, would be easier to transport and distribute to the marketplace thereby benefiting the environment by requiring fewer resources in the distribution process.
11. This unit, being substantially lighter and smaller than the common keyboard, would require less storage space during manufacturing, warehousing and storage at retail locations thereby benefiting the environment by requiring fewer resources.

### BRIEF DESCRIPTION OF THE DRAWINGS

A preferred form of the present invention will now be described by way of example with reference to the accompanying drawings, wherein:

FIG. 1 is a schematic plan of the keyboard; and

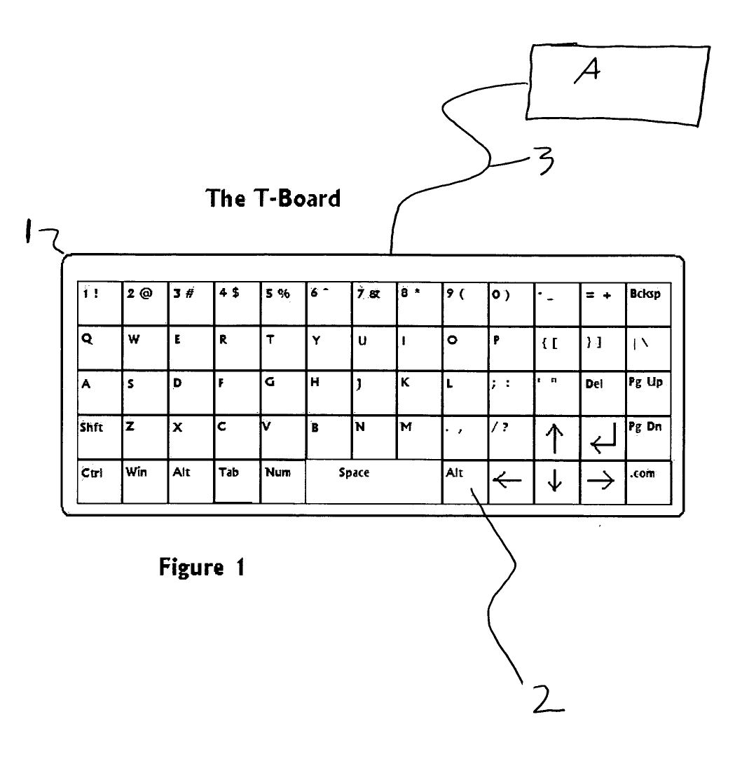

FIG. 2 is a schematic elevation of the keyboard of FIG. 1 showing the integrated USB port.

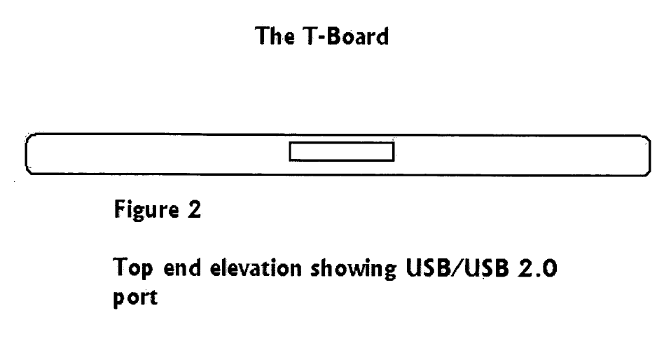

### DETAILED DESCRIPTION OF THE PREFERRED ENVIRONMENT

The present invention relates to a keyboard 1 to be used, for example, at a computer terminal/computer processing unit/notebook computer/laptop computer (A). In the accompanying drawings there is schematically depicted a keyboard generally indicated by reference numeral 1. Keyboard 1 comprises a single unit having mounted thereon a plurality of depressible keys 2.

The keyboard will be connected to A via a standard universal serial bus (“USB”) cable 3 which could utilize plug in connectors at both ends of the standard USB or mini-USB size, or, alternatively, could be hard wired at the keyboard end with standard USB connection at the end designed to connect with A.

I claim:

1. A keyboard for hand-held use;

2. The keyboard in claim 1 which could also be used on a horizontal surface;

3. The keyboard of claim 2 comprising a single module;

4. The keyboard of claim 3 comprising a lightweight unit;

5. The keyboard of claim 4 comprising a small, “pocket-sized” unit;

6. The keyboard of claim 5 which is easily transportable by the user;

7. The keyboard of claim 6 which is easily manufactured using fewer raw materials;

8. The keyboard of claim 7 which is easily stored after manufacture using less space;

9. The keyboard of claim 8 which is easily distributed to retail locations after manufacture using less transportation resources and fuel;

8. The keyboard of claim 9 which is easily requires less space on the desktop of the work or study environment;

9. The keyboard of claim 8 which is easily transported by the user from place to place as needed thereby providing a convenience to the user;

10. The keyboard of claim 9 which is reduces waste at the end of its useful life when the same may be recycled.

11. The keyboard of claim 10 which could reduce user injury of the types commonly experienced by users of normal keyboards including wrist pronation, wrist supination, repetitive stress injury, postural deterioration and carpal tunnel syndrome.
